(19) United States
(12) Patent Application Publication
(10) Pub. No.: US 2019/0071924 A1
(43) Pub. Date: Mar. 7, 2019

(54) Self-Adhesive Blackout Shade

(71) Applicant: Beth Seaman, Los Angeles, CA (US)

(72) Inventor: Beth Seaman, Los Angeles, CA (US)

(21) Appl. No.: 16/123,237

(22) Filed: Sep. 6, 2018

Related U.S. Application Data
(60) Provisional application No. 62/555,570, filed on Sep. 7, 2017.

(51) Int. Cl. E06B 9/24

(52) U.S. Cl. CPC E06B 9/24; E06B 2009/2417

(57) ABSTRACT

A self-adhesive blackout shade for controlling the amount of external light sources allowed into a room or workspace. The self-adhesive blackout shade includes a panel having a first side designed to face an incoming light source and reflect a first portion of the incoming light ay from the panel and a second side designed to absorb a second non-reflected portion of light from the incoming light source and prevent any non-reflected light from passing through the panel. Additional structural support for the panel ca be provided by a rigid member extending around a perimeter of the panel between the first side and second side. The panel further includes a plurality of magnets disposed between the first side and second side of the panel are designed to interact with a plurality of metallic anchors, such that the panel can be removably secured to a surface via the plurality of metallic anchors.

### CROSS REFERENCE TO RELATED APPLICATION

This application claims the benefit of U.S. Provisional Application No. 62/555,570 filed on Sep. 07, 2017. The above identified patent application is herein incorporated by reference in its entirety to provide continuity of disclosure.

### BACKGROUND OF THE INVENTION

The present invention relates to an instrument for controlling tele amount of external light sources allowed into a room or workspace. More specifically, the present invention provides a two-sided panel having a reflective first side and a light absorbing second side that produce the combined effect of preventing any tight from passing through when installed over a window surface. The panel also includes a set of built-in magnets and repositionable metal anchors that allow greater variability with respect to where the panel can be installed or positioned.

Many people have difficulty falling asleep when there is any level of light in the room. Additionally, children sensitive to light can have trouble sleeping, which in turn can have the cascading effect of keeping the parents awake as well. Furthermore, film production crews and photographers require a greater level of control the amount of external light allowed into a room or on a set in order to produce the highest quality work. Traditional window shades and curtains cannot prevent all light from entering a room, and standard blackout shades can be time consuming, frustrating, and difficult to install and reposition. Therefore, a device that can easily and removably secure to a window to prevent any light from entering is needed.

Devices have been disclosed in the known art that relate to repositionable window coverings and privacy screens. These include devices that have been patented and published in patent application publications. These devices generally relate to privacy screens or window covering that rely on external fasteners, however one of these deuces disclose a two-sided panel with light reflecting and light absorbing properties along with built-in magnetic fasteners

In light of the devices disclosed in the known art, it is submitted that the present invention substantially diverges in design elements from the known art and consequently it is clear that here is a need in the art for an improvement to existing self-adhesive blackout shade devices. In this regard the instant invention substantially fulfills these needs.

### SUMMARY OF THE INVENTION

In view of the foregoing disadvantages inherent in the known types of repositionable window covering now present in the known art, the present invention provides a new repositionable window covering wherein the same can be utilized for providing convenience for the user when regulating the amount of external light sources allowed into a room or workspace.

It is therefore an object of the present invention to provide a new and improved self-adhesive blackout shade device that has all of the advantages of the known art and none of the disadvantages.

Another object of the present invention is to provide a self-adhesive blackout shade, comprising a panel, a rigid member, a plurality of magnets, and a plurality anchors, all jointly configured to regulate the amount of light allowed to enter into a room or workspace.

Yet another object of the present invention is to provide a panel, having a first side and a second side, configured to cover a surface.

A further object of the present invention is to provide a panel, wherein the first side of the panel comprises a reflective material configured to face toward an incoming light source such that a first portion of the incoming light is reflected away from the panel.

Another object of the present invention is to provide a panel, wherein the second side of the panel comprises an opaque material configured to absorb a second non-reflected portion of light from the incoming light source, such that no light from the incoming light source can entirely pass through the panel.

Yet another object of the present invention is to provide a plurality of magnets disposed between the first side second side of the panel, that are configured to interact with a plurality of metallic anchors, such that the panel can be removably secured to a surface via the plurality of metallic anchors.

An additional object of the present invention is to provide a plurality of metallic anchors in the form of ferrous plates that are configured to be positioned on a surface, such that an attractive magnetic force is created between the plurality of ferrous plates and the plurality of magnets disposed in the panel.

Still another object of the present invention is to provide a plurality of ferrous plates coated with an adhesive configured to secure the plurality of ferrous plates to the surface and support the additional weight of the panel and the plurality of magnets disposed therein.

A further object of the present invention is to provide a rigid member that extends around a perimeter of the panel between the first side and second side, such that the rigid member provides structural support for the panel.

Yet another object of the present invention is to provide a panel, wherein the plurality of magnets are disposed along the rigid member extending around the perimeter of the panel.

An additional object of the present invention is to provide a panel configured to be folded against itself such that a section of the surface is left uncovered allowing a portion of light to pass by unencumbered.

Another object of the present invention is to provide a self-adhesive blackout shade that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description taken in connection with the accompanying drawings wherein like numeral annotations are provided throughout.

FIG. 1A shows an exploded view of an embodiment of a self-adhesive blackout shade including a rigid member and a plurality of magnets.

FIG. 1B shows an exploded view of an embodiment of a self-adhesive blackout shade having a reflective first side and an opaque second side, without a rigid member disposed therebetween.

FIG. 1C shows a logical view of how an incoming beam of light is partially reflected by the first side and partially absorbed by the second side of the panel.

FIG. 2A shows a perspective view of a panel being installed over a surface via the attractive forces between the plurality of magnets and a plurality metallic anchors in an embodiment of a self-adhesive blackout shade.

FIG. 2B shows a perspective view of a panel being installed over an alternate surface via the attractive forces between the plurality of magnets and a plurality of metallic anchors in an embodiment of a self-adhesive blackout shade.

FIG. 3A shows a perspective view of a panel of an embodiment of a self-adhesive blackout shade in use covering a window surface.

FIG. 3B shows a perspective view of a panel of an embodiment of self-adhesive blackout shade in use covering a window surface, where a portion of the panel is folded back to allow some light to pass through unencumbered.

### DETAILED DESCRIPTION OF THE INVENTION

Reference is made herein to the attached drawings. Like reference numerals are used throughout the drawings to depict like or similar elements of the self-adhesive blackout shade. For the purposes of presenting a brief and clear description of the present invention, the preferred embodiment will be discussed as used for regulating a the amount of light allowed to enter into a room or workspace. The figures are intended for representative purposes only and should not be considered to be limiting in any respect.

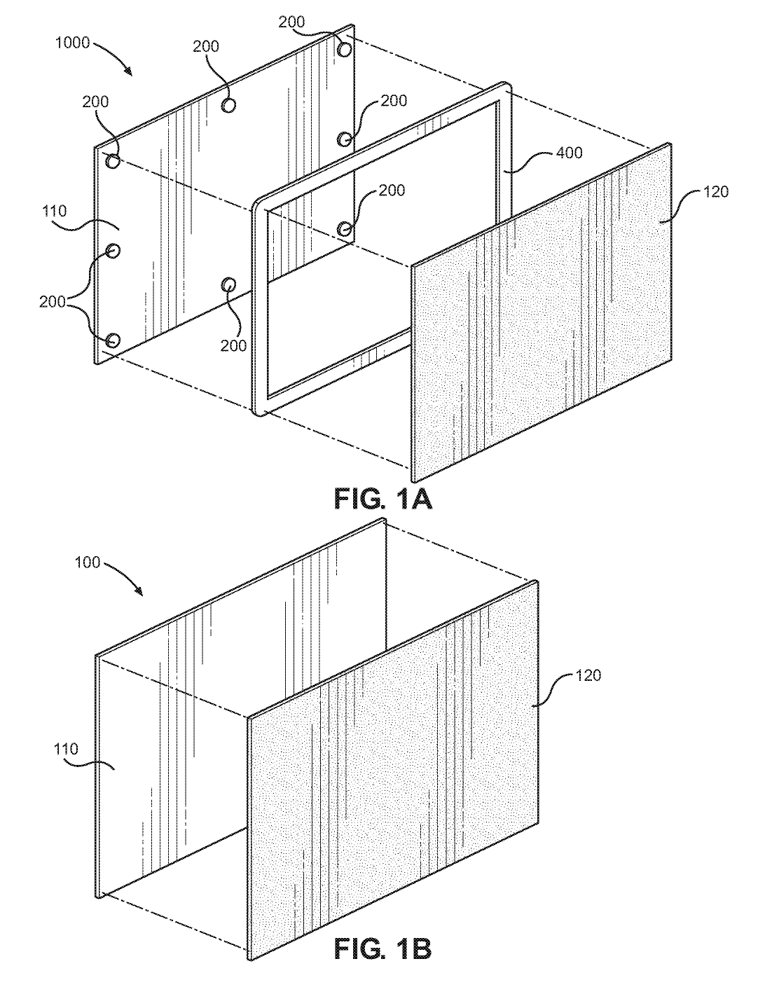

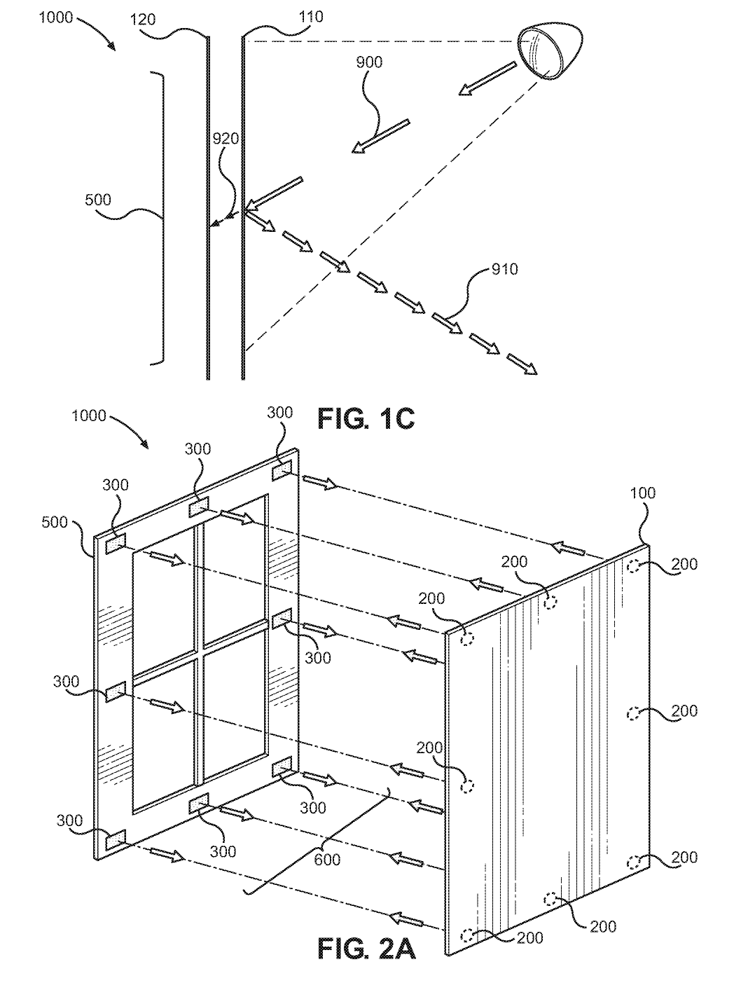

Deferring nous to FIGS. 1A, 1B, and 1C, there are shown an exploded view of an embodiment of a self-adhesive blackout shade including a rigid member an plurality magnets, an exploded view of an embodiment of a self-adhesive blackout shade having a reflective first side and an opaque second side, without a rigid member disposed therebetween, and a logical view of how an incoming beam of light is partially reflected by the first side and partially absorbed by the second side of the panel, respectively. In the illustrated embodiment a self-adhesive blackout shade 1000, comprises a panel 100 having a first side 110 and a second side 120, such that the panel 100 is configured to cover a surface 500, like a window or opening that allows some portion of light to pass therethrough. The first side 110 of the panel 100 comprises reflective material configured to face toward an incoming light source 900 and reflect a first portion of the incoming light 910 away from the panel 100. The second side 120 of the panel 100 comprises an opaque material configured to absorb a second non-reflected portion of light 920 from the incoming light source 900, such that the non-reflected portion of light 920 from the incoming light source 900 is unable to entirely pass through the panel 100.

In some embodiments a rigid member 400 extends around a perimeter 130 of the panel 100 between the first side 110 and second side 120, such that the rigid member 400 can provide additional structural support for the panel 100, which can make the panel easier to maneuver when installing or positioning over a desired surface 500. In other embodiments a plurality of magnets 200 can be disposed along the rigid member 400 extending around the perimeter 130 of the panel 100.

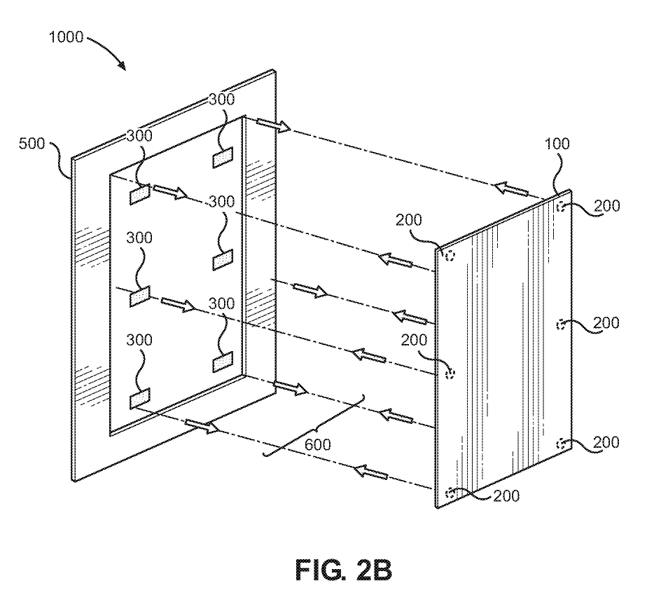

Referring now to FIGS. 2A and 2B, there is shown a perspective view of a panel being installed over a surface via the attractive forces between the plurality of magnets and a plurality of metallic anchors in an embodiment of a self-adhesive blackout shade and a perspective view of a panel being installed over an alternate surface via the attractive forces between the plurality of magnets and a plurality of metallic anchors in an embodiment of a self-adhesive blackout shade, respectively. In the illustrated embodiment the plurality of magnets 200 disposed between the first side 110 and second side 120 of the panel 100 are configured to interact with a plurality of metallic anchors 300, such that the panel 100 can be removably secured to the surface 500 via the plurality of metallic anchors 300. In some embodiments the plurality of magnetic anchors 300 are ferrous plates configured to be positioned on the surface 500, such that an attractive magnetic force 600 is created between the plurality of metallic anchors 300 and the plurality of magnets 200 disposed in the panel 100. The magnetic anchors 300 are configured to secure to various surfaces, such as a window frame (as seen in FIG. 2A) or directly to a window (as seen in FIG. 2B). The magnetic anchors are configured to secure to the surface 500 and not cause any damage to the surface 500.

Furthermore, in the illustrated embodiment the plurality of metallic anchors 300 are coated with an adhesive 350 configured to secure the plurality of ferrous plates 300 to the surface 500 and support the additional weight of the panel 100 and the plurality of magnets 200 disposed therein.

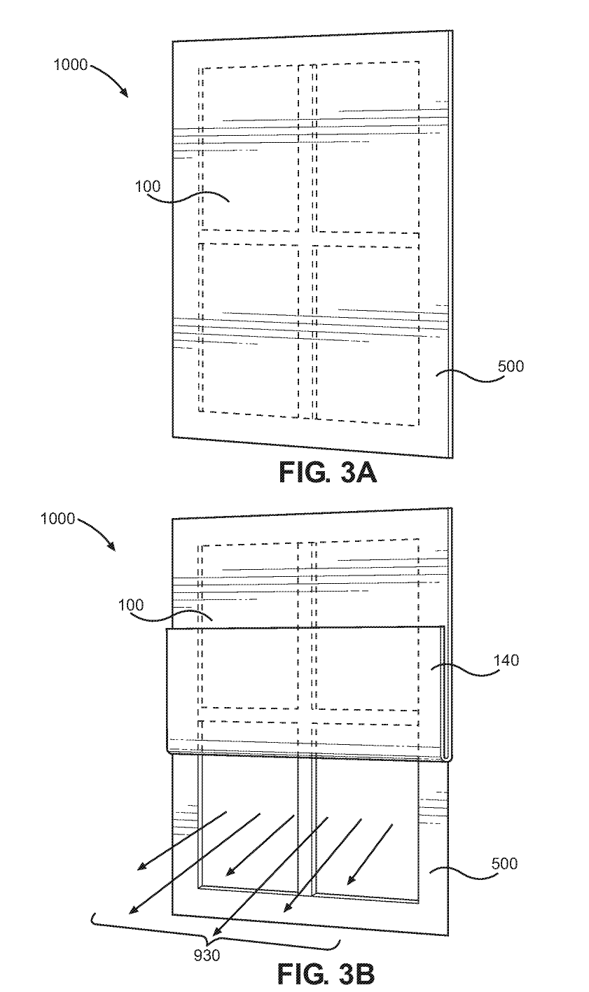

Referring now to FIGS. 3A and 3B, there are shown a perspective view of a panel of an embodiment of a self-adhesive blackout shade in use covering a window surface, and a perspective view of a panel of an embodiment of a self-adhesive blackout shade in use covering a window surface, where a portion of the panel is folded back to allow some light to pass through unencumbered, respectively. In the illustrated embodiment the panel 100 is further configured to be folded against itself such that a section 510 of the surface 500 is left uncovered allowing an unencumbered portion of light 930 to pass by. This foldability feature is useful in instances where the user desires to moderate, but not completely block out incoming light into the room or workspace.

It is therefore submitted that the instant invention has been shown and described in what is considered to be the most practical and preferred embodiments. It is recognized, however, that departures may be made within the scope of the invention and that obvious modifications occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes readily occur to those skilled in the art, it is not desired to limit the invention to the exact construction and operation shown and described, and accordingly, all suitable modifications and equivalents may be resorted to, falling within the scope of the invention.

I claim:

1. A self-adhesive blackout shade, comprising:
a panel having a first side and a second side is configured to cover a surface;
wherein the first side of the panel comprises a reflective material configured to face toward an incoming light source and reflect a first portion of the incoming light away from the panel;
wherein the second side of the panel comprises an opaque material configured to absorb a second non-reflected portion of light from the incoming light source, such that no light from the incoming light source can entirely pass through the panel;
a plurality of magnets disposed between the first side and second side of the panel are configured to interact with a plurality of metallic anchors, such that the panel can be removably secured to the surface via the plurality of metallic anchors;
wherein the plurality of ferrous plates are configured to be positioned on the surface, such that an attractive magnetic force is created between the plurality of ferrous plates and the plurality of magnets disposed in the panel.

2. The self-adhesive blackout shade of claim 1, wherein the plurality of metallic anchors are ferrous plates.

3. The self-adhesive blackout shade of claim 1, wherein the plurality of metallic anchors are coated with an adhesive configured to secure the plurality of ferrous plates to the surface and support the additional weight of the panel and the plurality of magnets disposed therein.

4. The self-adhesive blackout shade of claim 1, wherein a rigid member extends around a perimeter of the panel between the first side and second side, such that the rigid member provides structural support for the panel.

The self-adhesive blackout shade of claim 4, wherein the plurality of magnets are disposed along the rigid member extending around the perimeter of the panel.

6. The self-adhesive blackout shade of claim 1, wherein the panel is further configured to be folded against itself such that a section of the surface is left uncovered allowing an unencumbered portion of light to pass by.

7. The self-adhesive blackout shade of claim 1, wherein the first side and second side of the panel comprise a same length, width, and depth as one another.
